(19) United States
(12) Patent Application Publication
(10) Pub. No.: US 2014/0273879 A1
(43) Pub. Date: Sep. 18, 2014

(54) METHOD AND APPARATUS FOR ABSORBED POWER CALIBRATION FOR UE

(71) Applicant: QUALCOMM Incorporated, San Diego, CA (US)

(72) Inventors: Philip David Coan, La Jolla, CA (US); Stanley Slavko Toncich, San Diego, CA (US); Tingfang Ji, San Diego, CA (US)

(73) Assignee: QUALCOMM Incorporated, San Diego, CA (US)

(21) Appl. No.: 14/202,764

(22) Filed: Mar. 10, 2014

Related U.S. Application Data
(60) Provisional application No. 61/778,126, filed on Mar. 12, 2013.

(51) Int. Cl. H04B 17/00

(52) U.S. Cl. CPC H04B 17/00
USPC 455/67.14

(57) ABSTRACT

Methods, systems, apparatuses, and computer program products are described for operating a wireless communications device. Multiple signals may be received at the wireless communications device. The device may determine a power measurement for each of the signals and may receive absorbed power values corresponding to each power measurement. The wireless communications device may then be calibrated using one or more of the absorbed power values and corresponding power measurements.

### CROSS REFERENCES

The present application for Patent claims priority to U.S. Provisional Patent Application No. 61/778,126 by Coan et al., entitled “Method and Apparatus for Absorbed Power Calibration for UE,” filed Mar. 12, 2013, assigned to the assignee hereof, and expressly incorporated by reference herein.

### BACKGROUND

The following relates generally to wireless communication, and more specifically to calibration and testing of wireless communications devices. Wireless communications systems are widely deployed to provide various communication services such as voice, video, packet data, messaging, broadcast, and the like. These systems may be multiple-access systems capable of supporting communication with multiple users by sharing the available network resources (e.g. time, frequency, and power). Examples of such multiple-access systems include code-division multiple access (CDMA) system, time-division multiple access (TDMA) systems, frequency-division multiple access (FDMA) systems, and orthogonal frequency-divisions multiple access (OFDMA) systems.

Generally, a wireless communications system may include a number of base stations, each of which may simultaneously support communication with multiple mobile devices. A mobile device may communicate with a base station on upstream and downstream links. The downstream link (or forward link) refers to the communication link from the base station to the mobile device, and the upstream link (or reverse link) refers to the communication link from the mobile device to the base station. In order to ensure proper operation of the mobile device in the wireless communications system, the mobile device may need to be calibrated and/or tested prior to its use. Typically, the calibration and/or testing involves connecting the mobile device to a calibration and/or test equipment. However, because of potential impedance mismatches between the mobile device and the calibration and/or test equipment, the calibration of the mobile device may sometimes be inaccurate which may later lead to different performance results being observed during various tests or improper operation.

### SUMMARY

The described features generally relate to one or more improved systems, methods, and/or apparatuses for calibrating a wireless communications device and for testing and using the calibrated wireless communications device. Further scope of the applicability of the described methods and apparatuses will become apparent from the following detailed description, claims, and drawings. The detailed description and specific examples are given by way of illustration only, since various changes and modifications within the spirit and scope of the description will become apparent to those skilled in the art.

A method for operating a wireless communications device may include receiving multiple signals by the wireless communications device and determining a power measurement for each received signal. The method further includes receiving absorbed power values corresponding to each of the power measurements and calibrating the wireless communications device using one or more of the absorbed power values and the corresponding power measurements. In some examples, the absorbed power values may be determined by subtracting a reflected power value from an incident power value.

In some examples, the method may further include receiving a table or a function that indicates correspondence between the absorbed power values and the power measurements from, for example, calibration equipment. In some examples, the power measurement may include a received signal strength indication (RSSI) measurement for each of the multiple signals. In some examples the method may also include configuring a switch in the wireless communications device to connect a test port of the wireless communications device with the calibration equipment. In certain examples, the absorbed power values may be determined based on a mismatch loss between the wireless communications device and a calibration equipment. In certain examples, the absorbed power values may be determined based on a standing wave ratio (SWR) associated with the wireless communications device and the SWR associated with a calibration equipment. In some examples the multiple signals and the absorbed power values may be received by the wireless communications device from a calibration equipment.

An apparatus for operating a wireless communications device may include means for receiving multiple signals and means for determining a power measurement for each of the signals. The apparatus further includes means for receiving absorbed power values corresponding to each of the power measurements, and means for calibrating the wireless communications device using one or more of the absorbed power values and corresponding power measurements.

In some examples, the absorbed power value for each power measurement may be determined by subtracting a reflected power value from an incident power value. In some examples, the apparatus may include means for receiving a table or function that indicates the correspondence between the absorbed power values and the power measurements. In some examples, the power measurement may include a received signal strength indication (RSSI) measurement for each of the multiple signals. In some examples, the table or the function may be received from a calibration equipment. In some examples, the apparatus may also include means for configuring a switch in the wireless communications device to connect a test port of the wireless communication device with the calibration equipment. In certain examples, the absorbed power values may be determined based on a mismatch loss between the wireless communications device and a calibration equipment. In certain examples, the absorbed power values may be determined based on a standing wave ratio (SWR) associated with the wireless communications device and the SWR associated with a calibration equipment. In some examples the multiple signals and the absorbed power values may be received from a calibration equipment.

An apparatus for operating a wireless communications device may include a processor communicatively coupled with a memory, wherein the memory stores computer program code that causes the processor to receive multiple signals, determine a power measurement for each signal, receive absorbed power values corresponding to each of power measurements, and calibrate the wireless communications device using one or more of the absorbed power values and the corresponding power measurements.

In some examples, the absorbed power value for each power measurement may be determined by subtracting a reflected power value from an incident power value. In some examples, the computer program code is further configured to cause the processor to receive a table or function that indicates the correspondence between the absorbed power values and the power measurements from a calibration equipment. The table or function may be stored at the wireless communications device. In some examples, the computer program code that causes the processor to determine power measurements for each of the plurality of signals may be further configured to cause the processor to determine a received signal strength indication (RSSI) measurement for each of the plurality of signals. In some examples, the computer program code may be further configured to cause the processor to select a calibration mode as a mode of operation for the wireless communications device.

In certain examples, the absorbed power values may be determined based on a mismatch loss between the wireless communications device and a calibration equipment. In certain examples, the absorbed power values may be determined based on a standing wave ratio (SWR) associated with the wireless communications device and the SWR associated with a calibration equipment. In some examples the multiple signals and the absorbed power values may be received by the transceiver module from a calibration equipment.

A computer program product may include a non-transitory computer-readable medium having code for causing at least one processor to receive multiple signals from a calibration equipment, code for causing the at least one processor to determine a power measurement for each of the signals, code for causing the at least one processor to receive, from the calibration equipment, absorbed power values corresponding to each of power measurements, and code for causing the at least one processor to calibrate the wireless communications device using one or more of the absorbed power values and corresponding power measurements.

In some examples, the absorbed power values may be determined by subtracting a reflected power value from an incident power value. In some examples, the non-transitory computer-readable medium may also have code for causing the at least one processor to receive a table or function that indicates the correspondence between the absorbed power values and the power measurements. In some examples, the code for causing the at least one processor to determine the power measurement for each of the multiple signals may also include code for causing the at least one processor to determine an RSSI measurement as the power measurement for each of the signals. In some examples, the non-transitory computer-readable medium may also have code for causing the at least one processor to configure a switch in the wireless communications device to connect a test port of the wireless communication device with a calibration equipment. In certain examples, the absorbed power values may be determined based on a mismatch loss between the wireless communications device and a calibration device. In certain examples, the absorbed power values are determined based on a standing wave ratio (SWR) associated with the wireless communications device and the SWR associated with a calibration equipment.

### BRIEF DESCRIPTION OF THE DRAWINGS

A further understanding of the nature and advantages of the present invention may be realized by reference to the following drawings. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 shows a diagram that illustrates an example of a wireless communications system according to various examples;

FIG. 2A shows a block diagram that illustrates an example of a user equipment architecture according to various examples;

FIG. 2B shows a block diagram that illustrates an example of a calibration module according to various examples;

FIG. 3 shows a diagram that illustrates an example of a receiver impedance and conducted calibration according to various examples;

FIG. 4 shows a diagram that illustrates an example of a calibration table according to various examples;

FIG. 5A shows a diagram that illustrates an example of a radiated condition according to various examples;

FIG. 5B shows a diagram that illustrates an example of a radiated test according to various examples;

FIG. 6A shows a diagram that illustrates an example of a simulated environment according to various examples;

FIG. 6B shows a diagram that illustrates an example of a simulated test environment according to various examples;

FIG. 7 is a flowchart of an example of a method for calibrating a wireless communications device according to various examples;

FIG. 8 is a flowchart of an example of a method for a wireless communications device according to various examples;

FIG. 9 is a flowchart of an example of a method for a wireless communications according to various examples; and

FIG. 10 is a flowchart of an example of a method for calibrating a wireless communication device according to various examples.

### DETAILED DESCRIPTION

The present description discloses methods, apparatuses, systems, and devices for calibrating and testing a wireless communications device. The calibration of the wireless communications device may include receiving multiple power signals at the wireless communications device and determining a power measurement for each received signal. The calibration of the wireless communication device may further include receiving absorbed power values corresponding to each power measurement. The method also includes calibrating the wireless communications device using one or more absorbed power values and the corresponding power measurements. The methods, apparatuses, systems, and devices disclosed herein may be applied to an error budget analysis for a radio access network (e.g. RAN4). The disclosed methods, apparatuses, systems, and devices may also increase the consistency of performance test results for different wireless communications devices.

Techniques described herein may be used for various wireless communications systems such as cellular wireless systems, Peer-to-Peer wireless communications, wireless local access networks (WLANs), ad hoc networks, satellite communications systems, among others. The terms “system” and “network” are often used interchangeably. These wireless communications systems may employ a variety of radio communication technologies such as Code Division Multiple Access (CDMA), Time Division Multiple Access (TDMA), Frequency Division Multiple Access (FDMA), Orthogonal FDMA (OFDMA), Single-Carrier FDMA (SC-FDMA), and/or other radio technologies. Generally, wireless communications are conducted according to a standardized implementation of one or more radio communication technologies called a Radio Access Technology (RAT). A wireless communications system or network that implements a Radio Access Technology may be called a Radio Access Network (RAN).

Examples of Radio Access Technologies employing CDMA techniques include CDMA2000, Universal Terrestrial Radio Access (UTRA), etc. CDMA2000 covers IS-2000, IS-95, and IS-856 standards. IS-2000 Releases 0 and A are commonly referred to as CDMA2000 1X, 1X, etc. IS-856 (TIA-856) is commonly referred to as CDMA2000 1xEV-DO, High Rate Packet Data (HRPD), etc. UTRA includes Wideband CDMA (WCDMA) and other variants of CDMA. Examples of TDMA systems include various implementations of Global System for Mobile Communications (GSM). Examples of Radio Access Technologies employing OFDM and/or OFDMA include Ultra Mobile Broadband (UMB), Evolved UTRA (E-UTRA), IEEE 802.11 (Wi-Fi), IEEE 802.16 (WiMAX), IEEE 802.20, Flash-OFDM, etc. UTRA and E-UTRA are part of Universal Mobile Telecommunication System (UMTS). 3GPP Long Term Evolution (LTE) and LTE-Advanced (LTE-A) are new releases of UMTS that use E-UTRA. UTRA, E-UTRA, UMTS, LTE, LTE-A, and GSM are described in documents from an organization named “3rd Generation Partnership Project” (3GPP). CDMA2000 and UMB are described in documents from an organization named “3rd Generation Partnership Project 2” (3GPP2). The techniques described herein may be used for the systems and radio technologies mentioned above as well as other systems and radio technologies.

Thus, the following description provides examples, and is not limiting of the scope, applicability, or configuration set forth in the claims. Changes may be made in the function and arrangement of elements discussed without departing from the spirit and scope of the disclosure. Various examples may omit, substitute, or add various procedures or components as appropriate. For instance, the methods described may be performed in an order different from that described, and various steps may be added, omitted, or combined. Also, features described with respect to certain examples may be combined in other examples.

Referring first to FIG. 1, a diagram illustrates an example of a wireless communications system 100. The wireless communications system 100 includes base stations (or cells) 105, wireless communications devices 115, and a core network 130. The base stations 105 may communicate with the wireless communications devices 115 under the control of a base station controller (not shown), which may be part of the core network 130 or the base stations 105 in various examples. Base stations 105 may communicate control information and/or user data with the core network 130 through backhaul links 132. In examples, the base stations 105 may communicate, either directly or indirectly, with each other over backhaul links 134, which may be wired or wireless communication links. The wireless communications system 100 may support operation on multiple carriers (waveform signals of different frequencies). Multi-carrier transmitters can transmit modulated signals simultaneously on the multiple carriers. For example, each communication link 125 may be a multi-carrier signal modulated according to the various radio technologies described above. Each modulated signal may be sent on a different carrier and may carry control information (e.g., reference signals, control channels, etc.), overhead information, data, etc.

The base stations 105 may wirelessly communicate with the wireless communications devices 115 via one or more base station antennas. Each of the base station 105 sites may provide communication coverage for a respective geographic coverage area 110. In some examples, base stations 105 may be referred to as a base transceiver station, a radio base station, an access point, a radio transceiver, a basic service set (BSS), an extended service set (ESS), a NodeB, eNodeB (eNB), Home NodeB, a Home eNodeB, or some other suitable terminology. The geographic coverage area 110 for a base station may be divided into sectors making up only a portion of the coverage area (not shown). The wireless communications system 100 may include base stations 105 of different types (e.g., macro, micro, and/or pico base stations). There may be overlapping coverage areas for different technologies.

In examples, the wireless communications system 100 is an LTE/LTE-A network. In LTE/LTE-A networks, the terms evolved Node B (eNB) and user equipment (UE) may be generally used to describe the base stations 105 and wireless communications devices 115, respectively. The wireless communications system 100 may be a Heterogeneous LTE/LTE-A network in which different types of eNBs provide coverage for various geographical regions. For example, each base station 105 may provide communication coverage for a macro cell, a pico cell, a femto cell, and/or other types of cell. Small cells such as pico cells, femto cells, and/or other types of cells may include low power nodes or LPNs. A macro cell generally covers a relatively large geographic area (e.g., several kilometers in radius) and may allow unrestricted access by UEs with service subscriptions with the network provider. A pico cell would generally cover a relatively smaller geographic area and may allow unrestricted access by UEs with service subscriptions with the network provider. A femto cell would also generally cover a relatively small geographic area (e.g., a home) and, in addition to unrestricted access, may also provide restricted access by UEs having an association with the femto cell (e.g., UEs in a closed subscriber group (CSG), UEs for users in the home, and the like). An eNB for a macro cell may be referred to as a macro eNB. An eNB for a pico cell may be referred to as a pico eNB. And, an eNB for a femto cell may be referred to as a femto eNB or a home eNB. An eNB may support one or multiple (e.g., two, three, four, and the like) cells.

The core network 130 may communicate with the base stations 105 via a backhaul link 132 (e.g., S1, etc.). The base stations 105 may also communicate with one another, e.g., directly or indirectly via backhaul links 134 (e.g., X2, etc.) and/or via backhaul links 132 (e.g., through core network 130). The wireless communications system 100 may support synchronous or asynchronous operation. For synchronous operation, the eNBs may have similar frame timing, and transmissions from different eNBs may be approximately aligned in time. For asynchronous operation, the eNBs may have different frame timing, and transmissions from different eNBs may not be aligned in time. The techniques described herein may be used for either synchronous or asynchronous operations.

The wireless communications devices 115 are dispersed throughout the wireless communications system 100, and each wireless communications device 115 may be stationary or mobile. A wireless communications device 115 may also be referred to by those skilled in the art as a user equipment (UE), a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. A wireless communications device 115 may be a cellular phone, a personal digital assistant (PDA), a wireless modem, a handheld device, a tablet computer, a laptop computer, a cordless phone, a wireless local loop (WLL) station, or the like. A wireless communications device 115 may be able to communicate with macro eNBs, pico eNBs, femto eNBs, relays, and the like.

The communication links 125 shown in the wireless communications system 100 may include uplink (UL) transmissions from a wireless communications device 115 to a base station 105, and/or downlink (DL) transmissions, from a base station 105 to a wireless communications device 115. The downlink transmissions may also be called forward link transmissions while the uplink transmissions may also be called reverse link transmissions.

In some examples of the wireless communications system 100, one or more of the wireless communications devices 115 may be calibrated using an absorbed power as a calibration input power. Calibrating the wireless communications devices 115 using the absorbed power as the calibration input power may account for impedance mismatches between the calibration equipment and the UE receiver. In particular, the use of absorbed power may allow to compensate for the signal loss that occurs due to the impedance mismatch.

Accounting for the signal loss may result in a more accurate calibration and may lead to smaller differences being observed between performance results in radiated (i.e. measured radiated) and simulated (i.e. simulated radiated) test environments. As used herein, the radiated environment refers to the environment in which power measurements are made for a known power density produced at the antenna aperture. The radiated environment, for example, may correspond to the environment of an anechoic chamber in which the antenna pattern is measured without cable connections, or modifying the device. The simulated environment refers to the environment in which power measurements are made for a user defined waveforms that represent a radiated environment. The simulated environment, for example, may correspond to an environment in which a test equipment is used as a channel emulator and measurements are performed using a cabled connection.

As discussed in more detail below, in a calibration mode, a wireless communications device 115 may receive multiple signals from a calibration equipment that sweep the wireless communications device 115 through a range of powers. For each received signal, the wireless communications device 115 may determine a signal power and store the determined power along with the corresponding output power indicated by the calibration equipment in a calibration table. In order to take into account for the power loss observed due to the impedance mismatch between the calibration equipment and the wireless communications device 115, the wireless communications device 115 may also receive (e.g., from the calibration equipment) absorbed power values corresponding to each power measurement from the calibration equipment and perform calibration based on the received absorbed power values. According to one example, the absorbed power values may be determined by subtracting a reflected power value from an incident power value. The absorbed power values along with the corresponding power measurements may be stored in a calibration table or as a function. The calibration information stored in the calibration table may be used by the calibrated wireless communications device 115 during, for example, a test to identify one or more operating points for the wireless communications device 115.

Turning to FIG. 2A, a diagram 200 is shown that illustrates a UE 215, a calibration equipment 270, and a test equipment 275. The calibration equipment 270 and the test equipment 275 may be coupled to the UE 215 during calibration and test operations, respectively. The UE 215 may have various other configurations and may be included or be part of a personal computer (e.g., laptop computer, netbook computer, tablet computer, etc.), a cellular telephone, a PDA, a digital video recorder (DVR), an internet appliance, a gaming console, an e-readers, etc. The UE 215 may have an internal power supply (not shown), such as a small battery, to facilitate mobile operation. The UE 215 may be an example of one or more of the wireless communications devices 115 of FIG. 1. The UE 215 may be referred to as a wireless communications device, a user equipment, or an mobile device in some cases.

The UE 215 may include antennas 267, a transceiver module 250, a memory 230, and a processor module 220, which each may be in communication, directly or indirectly, with each other (e.g., via one or more buses). The transceiver module 250 may be configured to communicate bi-directionally, via the antennas 267 and/or one or more wired or wireless links, with one or more networks, as described above. For example, the transceiver module 250 may be configured to communicate bi-directionally with base stations 105 of FIG. 1. The transceiver module 250 may be implemented as a separate transmitter module and a separate receiver module. The transceiver module 250 may include a modem configured to modulate the packets and provide the modulated packets to the antennas 267 for transmission, and to demodulate packets received from the antennas 267. While the UE 215 may include a single antenna, there may be examples in which the UE 215 may include multiple antennas 267.

The memory 230 may include random access memory (RAM) and read-only memory (ROM). The memory 230 may store computer-readable, computer-executable software code 235 containing instructions that are configured to, when executed, cause the processor module 220 to perform various functions described herein for calibrating a device for signal power measurements, for example. Alternatively, the computer-executable software code 235 may not be directly executable by the processor module 220 but be configured to cause the computer (e.g., when compiled and executed) to perform functions described herein.

The processor module 220 may include an intelligent hardware device, e.g., a central processing unit (CPU) such as those made by Intel® Corporation or AMD®, a microcontroller, an application-specific integrated circuit (ASIC), etc. The processor module 220 may process information received through the transceiver module 250 and/or to be sent to the transceiver module 250 for transmission through the antennas 267. The processor module 220 may handle, alone or in connection with a calibration module 260, various aspects of calibrating a device for signal power measurements.

According to the architecture of FIG. 2A, the UE 215 may further include a communications management module 240. The communications management module 240 may manage communications with other user equipments and/or with various base stations (e.g., macro cells, small cells). By way of example, the communications management module 240 may be a component of the UE 215 in communication with some or all of the other components of the UE 215 via a bus (as shown in FIG. 2A). Alternatively, functionality of the communications management module 240 may be implemented as a component of the transceiver module 250, as a computer program product, and/or as one or more controller elements of the processor module 220.

The calibration module 260 is shown in FIG. 2A as being part of the transceiver module 250, however, other implementations may be possible where the calibration module 260 is separate from the transceiver module 250. The calibration module 260 may be configured to perform different functions, including configuring the UE 215 for calibration (e.g., with the calibration equipment 270) or testing (e.g., with the test equipment 275), performing power measurements on the received signals, such as, for example, received signal strength indication (RSSI) measurements, selecting an operating mode of the UE 215 and identifying operating points in various modes of operation.

The components of the UE 215 may be configured to implement aspects discussed below with respect to methods 700, 800, and 900 of FIG. 7, FIG. 8, and FIG. 9, respectively, and those aspects may not be repeated here for the sake of brevity.

Turning to FIG. 2B, a diagram 280 shows an example of the calibration module 260 of the UE 215 of FIG. 2A. The calibration module 260, according to this example, includes a measurements module 261 configured to perform power measurements (e.g., RSSI measurements) on calibration and/or test signals received from a calibration equipment 270 and/or test equipment 275. The measurements module 261, for example, may measure power for a plurality of signals received from the calibration equipment 270 and/or test equipment 275 that correspond to various transmit power settings selected at the calibration equipment 270 and/or test equipment 275.

The calibration module 260 may also include a calibration profile module 262 configured to store and/or create UE 215 calibration information. In one example, the calibration information may be stored by the calibration profile module in a form of a table. Alternatively, the calibration information may be stored as a function. The calibration information stored in the calibration table or as a calibration function may include the correspondence between absorbed power at the receiver of the UE 215 and the power measurements made by the measurements module. The calibration module 260 may also include an identification module 263 configured to identify operating points to be used by the UE 215 based on the calibration information stored in the calibration table. For example, the identification module may determine the operating points to use during different modes of operation. The calibration module 260 may also include a selection module 264 configured to select one of the identified operating points and/or operating mode. The calibration module 260 may also include a configuration module 265 that may configure a switch to enable the UE 215 to operate in a particular mode of operation (e.g., calibration, radiated, simulated, etc.).

Turning next to FIG. 3, there is shown a diagram that illustrates a system 300 that can be used to calibrate a user equipment (UE) according to some of the aspects of the disclosure. According to some examples, the system shown may be part of a wireless communication device or a user equipment such as the wireless communications device 115 shown in FIG. 1 or UE 215 shown in FIG. 2A. The system shown may include an antenna 305 which may be coupled to a match and losses unit 310. The antenna 305 may be an example of the antennas 267 shown in FIG. 2A. The match and losses unit may represent one or more of the system components that may contribute to the power losses observed in the system. As shown in FIG. 3, the match and losses unit 310 may be coupled to a first port of a switch 330 that may serve as a UE 215 test port connector. A calibration equipment 320 may be coupled to a second port of the switch 330. According to one example, the calibration equipment may be an radio frequency (RF) equipment. The calibration equipment may include cabling that connects the calibration equipment to the device being calibrated. A receiver 340, which may perform signal power measurements on signals received from the calibration equipment 320 may be coupled to the third port of the switch 330. In one example, the receiver 340 may be part of the transceiver module 250 of the UE 215 of FIG. 2A.

In the system 300, position of the switch 330 determines the mode in which the system operates. According to one example, the various modes of operation for the system 300 may include: a normal mode, a radiated mode, a simulated mode and a calibration mode. The mode of operation, according to one example, may be determined by the configuration module 265 discussed above with reference to FIG. 2B. During the normal mode of operation, the switch 330 may be set to connect the antenna 305 to the receiver 340 of the UE 215. This switch position may also be used during a radiated mode (i.e. in a measured radiated environment) that corresponds to a first stage of a two-stage test method. As discussed herein, the two-stage test method refers to a test method in which a model of the antenna 305 is generated during first stage of the test based on known power densities produced at the antenna aperture (i.e. desired wave forms and/or impairments generated by test equipment). The generated model is subsequently integrated with a simulated radiated environment that is used to test the UE 215 during a second stage. The antenna model generated during the first stage may provide, for example, directivity, gain, signal losses, as well as three-dimensional information.

During calibration (i.e. calibration mode) and/or during the second stage of the two-stage test method (i.e. simulated radiated mode), the switch 330 may be positioned to connect the calibration equipment 320 and/or test equipment cabled into the UE 215 test port to the receiver 340. While in the calibration mode the UE 215 may be swept over a range of power signals at its input port and perform corresponding power measurements for each received signal at its output. In order to ensure that the measurements made during calibration are correct, and the later performed power measurements are correctly interpreted, an impedance mismatch between the input impedance of the source (i.e. calibration equipment including the cable) and of the load (i.e. receiver 340) need to be accounted for.

In the system shown in FIG. 3, the impedance mismatch typically results from the fact that the impedance of the receiver, which is design-specific for a given UE over an operating frequency range, does not match the impedance of the calibration and/or test equipment Zᵢₙ (equipment) used to drive the wireless communications device 115, which is typically 50 ohms. In general, the impedance of the receiver Zᵢₙ(rx), corresponds to the impedance of a cascade of several components, such as, for example, switch-plexer, filters and low noise amplifier (LNA), among others. Typically, the overall impedance Zin(rx) of the receiver 340 is dominated by the SWR of the switch-plexer/bandpass filter (BPF) or a RX BPF part of a duplexer of the switch 330 which are lossy elements at the input stage to the receiver 340.

Table 1 includes some illustrative SWR data from several BPF/duplexer or switch-plexer/BPF vendors. As shown in Table 1, the load on a switch-plexer or input filter (e.g., the low-noise amplified or active circuits) in the switch 330 is between 1.4:1 and 2.0:1 for the typical vendor switches, with a maximum SWR of about 2.5:1. Although the SWR values may be taken directly from specifications provided by different switch vendors, the SWR values and the effect of the SWR of the switch 330 on the overall impedance Zin(rx) of the receiver 340 may also be determined by conducting radio frequency (RF) simulations using RX BPF models, or models for the RX BPF portion of a duplexer, with cascaded switch models. These simulations results have been shown to closely align with specifications provided by different high volume filter/switch-plexer vendors listed in Table 1.

TABLE 1

| | SWR | |
|---|---|---|
| | (typ/max) | |
| Vendor | (n:1) | Bands Covered |
| BPF/duplexer A | 1.75/2.0 | Cell-; L-Band |
| BPF/duplexer B | 1.75/2.0 | Cell-; L-Band |
| BPF C | 2.0/2.5 | Cell-; L-Band |
| Switch-plexer A | 1.4/2.0 (typ) | Cell- and L- |
| | | Band |

Returning now to the calibration of the UE 215 receiver power using the system 300 shown in FIG. 3, the calibration procedure may involve sweeping the receiver 340 of the UE 215 through a range of power signals and measuring signal power for each signal. Specifically, the calibration equipment 320, which may include an RF equipment, may be used to generate a plurality of power signals and to report the output power for each generated power signal. The receiver 340 of the UE 215 may measure signal power (e.g., RSSI measurements) for each received signal. The output power reported by the calibration equipment (i.e. incident power) along with the RSSI measurements performed by the UE 215 may be stored at the UE 215 as a calibration profile by the calibration profile module 262 shown in FIG. 2B.

According to one example, the calibration profile module may create and/or store a calibration table that includes UE 215 calibration information. Alternatively, the calibration table may be created by the calibration equipment 320 and then loaded into the UE 215. Additionally, the calibration equipment may, for each of the generated power signal, determine and report an absorbed power value. As discussed above, because the impedance of the receiver 340 may not be perfectly matched to the 50 ohm impedance of the calibration equipment 320, there may be a certain amount of signal power loss that occurs during calibration due to the mismatch. That is, the impedance mismatch causes some of the incident power to be reflected back to the calibration equipment 320. For example, for an SWR=2.5:1, the mismatch loss (ML) of approximately 0.87 dB may be observed. Determining the amount of signal loss due to the mismatch and the corresponding absorbed power may result in more accurate calibration profile being created for the UE 215. In other words, determining and using the absorbed power that is received by the UE 215 during calibration and not the incident power provided by the calibration equipment 320 may lead to more accurate calibration of the UE 215.

FIG. 4 show a diagram 400 of an example calibration table 410, that may be created after UE 215 is calibrated by the calibration equipment 320 of FIG. 3. As shown in FIG. 4, the calibration table 410 may include power measurements (e.g., RSSI measurements) that correspond to the determined absorbed power values rather than the actual incident power values reported by the calibration equipment.

For the specific example shown, an absorbed power value of −51 dBm at the receiver 340 in FIG. 3 may correspond to an incident power value reported at the output of the calibration equipment 320 of −50 dBm with an assumed power loss of 1 dBm due to the impedance mismatch. This absorbed power input may produce a first RSSI measurement (RSSI 1), which may be equal to the absorbed power value of −51 dBm if no other losses and/or errors are introduced during the measurement.

Therefore, the UE with the receiver 340 may identify a subsequent RSSI 1 measurement with −51 dBm. Similarly, when the calibration equipment 320 provides signals with power that result in absorbed power values of −52 dBm and −53 dBm, the receiver 340 produces a second RSSI measurement (RSSI 2) and a third RSSI measurement (RSSI 3). Again, the UE with the receiver 340 may identify a subsequent RSSI 2 measurement with −52 dBm and a subsequent RSSI 3 measurement with −53 dBm.

In addition, according to another example, table shown in FIG. 4 may include a difference between the calculated absorbed power and the corresponding RSSI measurements. This difference may be used to correct for any other system introduced errors. For example, for an RSSI 1 measurement of −51.1 dBm that corresponds to the absorbed power value of −51 dBm, a correction of −0.1. dBm would need to be made to any later performed power measurements to account for the system introduced errors.

Furthermore, when looking at the values shown in the table of FIG. 4, it is important to note that if the calibration table was created based on the incident power values rather than the absorbed power values an error of 1 dBm would have been introduced into the system. In other words, if the incident power of −50 dBm reported by the calibration equipment were included in the table instead of the absorbed power of −51 dBm along with the corresponding RSSI 1 measurement, an adjustment to the measurements performed at a later time in test environment, would be made using the incorrect calibration table. In particular, for the example discussed above, an incident power of −50 dBm in a radiated environment would be adjusted by 1 dBm using the incorrectly constructed calibration table, leading to an RSSI 1 value of −49 dBm being reported for the incident power of −50 dBm during the test.

The discussion will now turn to using the disclosed system during a two-stage test. Shown in FIG. 5A, is a diagram 500 that illustrates a system that may be used to test a user equipment, such as the UE 215 in FIG. 2A in a radiated environment. According to one example, the radiated environment in which the UE 215 may be tested includes an anechoic test chamber. The example system shown includes an antenna 505 coupled to a match and losses unit 510 and to a first port of a switch 530. The antenna 505 may be an example of the antennas 267 of the UE 215 of FIG. 2A. Also coupled to the switch 530 is a receiver 540, which may perform signal power measurements on signals received from the antenna 505. The receiver 540, according to one example, may be part of the transceiver module 250 of the UE 215 of FIG. 2A.

When operated in a measured radiated environment, the UE 215 with the receiver 540 shown in FIG. 5A may be subjected to power signals of known power densities produced at the aperture of the antenna 505. These signals may be known radio frequency (RF) power signals delivered to the aperture of the antenna 505 by a test equipment (not shown). The UE may use a calibration table, such as the calibration table 410 of FIG. 4, generated during calibration, to interpret power measurements performed by the receiver 540 during radiated test.

FIG. 5B, illustrates a specific example of a system 550 undergoing radiated test. In the example shown, the antenna 505 is assumed to be ideal with directivity, ohmic and mismatch losses being equal to 0 dB. This assumption may be valid for the radiated environment since the antenna losses (e g ohmic, mismatch) that may occur in the radiated mode typically do not affect the power incident on the antenna aperture and thus do not affect testing. Instead, these losses are generally absorbed by the receiver.

As shown in the example, the aperture of the antenna 505 has a power, Pant, equal to −50 dBm delivered to it. Because the antenna is assumed to be lossless the incident power Pinc and Pabs are both assumed to be equal to the Pant=−50 dBm. For the UE 215 calibrated using the incident power values instead of the absorbed power values, the power measurements reported by the receiver 540 reflect the error introduced during calibration. In particular, for the specific example discussed above, the error of 1 dBm introduced by the improper calibration, would result in the RSSI measurement of −49 dBm power being reported for the incident power Pinc=Pabs of −50 dBm. On the other hand, for the UE 215 calibrated with the absorbed power values the RSSI measurements would correctly reflect the incident power values. Specifically, the UE calibrated using the absorbed power values would correctly report the RSSI of −50 dBm for the incident power of −50 dBm.

Turning now to FIG. 6A, there is shown a diagram 600 that illustrates a system that may be used to test simulated radiated conditions in a user equipment, such as the UE 215 in FIG. 2A. Portions of the system illustrated in FIG. 6A may be part of a wireless communications device or UE being tested. As shown in the figure, in the simulated radiated environment an antenna 605 is bypassed. A test equipment 620 including a cable, such as for example a coaxial cable is coupled to a second port of the switch 630. Also coupled to the switch 630 is a receiver 640, which may perform signal power measurements on signals received from the test equipment 620. The receiver 640 may be part of the transceiver module 250 of the UE 215 of FIG. 2A.

In the simulated radiated environment mode shown in FIG. 6A a user-selected waveform is supplied to the receiver 640 via the test equipment 620 and the coaxial cable, in a similar manner as during the calibration mode discusses above with reference to FIG. 3. By using a measured pattern of the antenna 605, the test equipment 620 may deliver a waveform that replicates the incident power at the aperture of the antenna 605. The UE 215 may perform signal power measurement for each of the supplied power input and may use the calibration table (e.g., calibration tables 410) to set its operating point based on the power level at the switch 630.

While in the test mode, the power level of the test equipment 620 may be affected by some degree of uncertainty. Errors and uncertainties in the calibration equipment (e.g., calibration equipment 320), test equipment (e.g., test equipment 620), in the absorbed power to the receiver (e.g., receiver 340, 540, 640), and/or in the incident power to the receiver may all have an impact on the receiver's operating point accuracy. For example, the accuracy of the receiver's perception of the amount of power delivered to the antenna during a radiated mode may be negatively affected by errors and uncertainties introduced by the calibration and test equipment during a test mode.

In FIG. 6B, a diagram 650 illustrates a specific example of a simulated radiated test environment. In the example shown, the parameter of the antenna 605 and the incident power levels to the antenna 605 are programmed into the test equipment 620. As illustrated in the figure, when the test equipment is set to produce an incident power Pinc of −50 dBm at its output, as in the radiated test case described above with reference to FIG. 5B, the absorbed power Pabs at the receiver 640 is equal to −51 dBm for the assumed 1.0 dB losses that may occur due to the impedance mismatch between the test equipment and the receiver. In the case the power measurements at the receiver are interpreted using a calibration table created based on the incident power values instead of the absorbed power values the Pabs level may be incorrectly interpreted by the receiver 640 as −50 dBm. For a UE 215 calibrated with the absorbed power values instead of incident power, on the other hand, a correct power measurement of −51 dBm that corresponds to the absorbed power at the receiver would be reported.

The various descriptions provided above make reference to standing wave ratios (SWRs) and mismatch losses (ML). Below are provided some equations that may be used to calculate the SWR and ML for a given arbitrary complex source and load impedance. The calibration equipment 320 in FIG. 3 and the test equipment 620 in FIG. 6A and FIG. 6B may be configured to perform one or more of these calculations. Moreover, there may be instances in which the UE 215 being calibrated or tested may have the capability to perform one or more of these calculations in connection with its own calibration or test.

For a network with an arbitrary source impedance Zₛ=Rₛ±jXₛ and a load impedance Z₁=R₁±jX₁, the following expressions may apply:

Reflection coeff: Γ=(Zₗ−Zₒ)/(Zₗ+Zₒ), (1)

ρ=mag(Γ)=([(Rₗ−Rₒ)²−(Xₗ±Xₛ)²]/[(Rₗ+Rₒ)²+(Xₗ±Xₛ)²])^{0.5} (2)

SWR=(1+ρ)/(1−ρ), (3)

Return Loss=RL=10*log(1/ρ²), (4)

ML=−10*log(1−ρ²). (5)

Here Zₛ represents the antenna as the source driving the receiver load. Both Zₛ and Zᵣ are frequency dependent impedances. For the case when a test equipment/coaxial cable is the source driving the receiver load, then Zₛ˜50 ohm (Ω) real. In that case the expression for ρ in (2) may have Xₛ set to 0Ω. For the general case of n, lossless complex impedances represented by SWR1, SWR2, SWR3, . . . , and SWRn, the interaction between them may be determined from equation (1) and is given by:

SWR(max)=SWR1*SWR2*SWR3* . . . SWRn. (6)

Equation (6) may be valid for a cascade of lossless or very low loss elements such as test equipment output impedance, coaxial cables and connectors. For the general case of cascaded elements with either loss, like filters and switch-plexers, or gain, like amplifiers, the cascaded expression in equation (6) may be replaced by the SWR expression in equation (3), which may be based on an arbitrary complex source and load impedance of the cascade.

Turning next to FIG. 7, a flowchart is shown of an example method 700 for calibrating a wireless communications device. The method 700 may be performed using, for example, the wireless communications device 115 of the wireless communications system 100 of FIG. 1; the UE 215 of FIG. 2A; and/or one or more of the components illustrated in FIG. 3, FIG. 5A, FIG. 5B, FIG. 6A, and FIG. 6B.

At block 705, multiple signals are received from, for example, a calibration equipment, such as the calibration equipment 320 of FIG. 3. At block 710, a power measurement is determined for each of the received signals. At block 715, a calibration profile for the wireless communications device is generated using an absorbed power value of each of the received signal and the corresponding power measurement.

In some examples of the method 700, the absorbed power value of each received signal may be determined by subtracting a reflected power value from an incident power value. According to some examples, a dual directional coupler may be introduced between the calibration equipment 320 and the receiver 340 in FIG. 3 to concurrently measure the incident power from the calibration equipment 320 and the reflected power from the receiver 340. The measured reflected power may be subtracted from the measured incident power to arrive at the absorbed power value. According to one example, the absorbed power values may be determined at calibration equipment. Alternatively, the absorbed power values may be determined at the wireless communications device.

In some examples, the calibration profile generated for the wireless communication device may include a correspondence between the absorbed power values and the power measurements. The calibration profile may be stored in the wireless communications device in a form of a table or as a function. The calibration profile may be received by the wireless communications device from the calibration equipment. Alternatively, the calibration profile may be generated by the wireless communications device. In some examples, an RSSI measurement may be determined as the power measurement for each of the signals. In some examples, a switch in the wireless communications device is configured to connect a test port of the wireless communication device with the calibration equipment.

Turning next to FIG. 8, a flowchart is shown of an example method 800 for operating a wireless communications device according to some aspects of the disclosure. The method 800, similar to the method 700 above, may be performed using, for example, the wireless communications system 100 of FIG. 1; the UE 215 of FIG. 2A and/or one or more of the components illustrated in FIG. 3, FIG. 5A, FIG. 5B, FIG. 6A, and FIG. 6B.

At block 805, multiple signals may be received from, for example, a calibration equipment (e.g., calibration equipment 320). At block 810, a power measurement is determined for each of the signals. At block 815 absorbed power values are received from the calibration equipment corresponding to each of the power measurements. At block 820, the wireless communications device is calibrated using the absorbed power values and the corresponding power measurements.

In some examples of the method 800, the absorbed power value of each received signal may be determined by subtracting a reflected power value from an incident power value. According to some examples, a dual directional coupler may be introduced between the calibration equipment 320 and the receiver 340 in FIG. 3 to concurrently measure the incident power from the calibration equipment 320 and the reflected power from the receiver 340. The measured reflected power may be subtracted from the measured incident power to arrive at the absorbed power value. According to one example, the absorbed power values may be determined at calibration equipment. Alternatively, the absorbed power values may be determined at the wireless communications device.

In some examples, the wireless communication device may receive a table or a function that indicates the correspondence between the absorbed power values and the power measurements, which may be stored in the wireless communications device. The table or the function may be received by the wireless communications device from the calibration equipment. Alternatively, the calibration profile may be generated by the wireless communications device. In some examples, an RSSI measurement may be determined as the power measurement for each of the signals. In some examples, a switch in the wireless communications device may be configured to connect a test port of the wireless communication device with the calibration equipment.

Turning next to FIG. 9, a flowchart is shown of another example method 900 for operating a wireless communications device. The method shown may be used to identify one or more operating points of a wireless communications device. The method 900, like the methods 800 and 700 above, may be performed using, for example, the wireless communications system 100 of FIG. 1; the UE 215 of FIG. 2A and/or one or more of the components illustrated in FIG. 3, FIG. 5A, FIG. 5B, FIG. 6A, and FIG. 6B.

At block 905, one or more operating points may be identified in a user equipment based at least in part on a stored calibration information that indicates a correspondence between signal power measurements and absorbed power values. At block 910, one of the operating points may be selected for use with an operating mode of the user equipment.

In some examples of the method 900, a radiated mode may be selected as the operating mode of the user equipment, and the one operating point may be selected for use with the radiated mode. In some examples, a switch in the user equipment may be configured to enable operation in the radiated mode. In some examples, the absorbed power value for each power measurement is determined by subtracting a reflected power value from an incident power value. In some examples, a table or function stored in the user equipment indicates the correspondence between the power measurements and the absorbed power values.

Turning next to FIG. 10, a flowchart is shown of an example method 1000 for calibrating a wireless communications device. The method 1000 may be performed, for example, by a calibration equipment 320 illustrated in FIG. 3.

At block 1005, multiple signals are generated by the calibration equipment 320 of FIG. 3 and provided to the a wireless communications device, such as UE 215 of FIG. 2A. At block 1010, a reflected power for each signal is determined by the calibration equipment. At block 1015, absorbed power values at the receiver are determined from an incident power value and the reflected power. At block 1015, a wireless communications device is calibrated using the absorbed power values.

In some examples of the method 1000, the absorbed power value of each received signal may be determined by subtracting a measured reflected power from a measured incident power. According to one example, a dual directional coupler may be introduced between the calibration equipment 320 and the receiver 340 in FIG. 3 to concurrently measure the incident power from the calibration equipment 320 and the reflected power from the receiver 340. Alternatively, the absorbed power may be determined from a mismatch loss between the wireless communications device and the calibration equipment based on the impedances of the wireless communications device and the impedance of the calibration equipment. In some examples a first SWR associated with the wireless communications device and a second SWR associated with the calibration equipment may be determined. The first and second SWRs may be combined and the mismatch between the calibration equipment and the wireless communications device may be determined based at least in part on the combined SWRs.

The detailed description set forth above in connection with the appended drawings describes exemplary examples and does not represent the only examples that may be implemented or that are within the scope of the claims. The term “exemplary” used throughout this description means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope and spirit of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items prefaced by “at least one of” indicates a disjunctive list such that, for example, a list of “at least one of A, B, or C” means A or B or C or AB or AC or BC or ABC (i.e., A and B and C).

Computer-readable media includes both computer storage media and communication media including any medium that facilitates transfer of a computer program from one place to another. A storage medium may be any available medium that can be accessed by a general purpose or special purpose computer. By way of example, and not limitation, computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The previous description of the disclosure is provided to enable a person skilled in the art to make or use the disclosure. Various modifications to the disclosure will be readily apparent to those skilled in the art, and the generic principles defined herein may be applied to other variations without departing from the spirit or scope of the disclosure. Throughout this disclosure the term “example” or “exemplary” indicates an example or instance and does not imply or require any preference for the noted example. Thus, the disclosure is not to be limited to the examples and designs described herein but is to be accorded the widest scope consistent with the principles and novel features disclosed herein.

Additional methods, apparatus, and computer program products for wireless communications are described. For example, a method for operating a wireless communications may include identifying, in a user equipment, one or more operating points based at least in part on stored calibration information that indicates a correspondence between signal power measurements and absorbed power values. The method also includes selecting one of the one or more operating points for use with an operating mode of the user equipment. In some examples, the method may include selecting a radiated mode as the operating mode of the user equipment, and selecting one of the one or more operating points for use with the radiated mode. In some examples, the method may include configuring a switch in the user equipment to enable operation in the radiated mode. In some examples, the absorbed power value for each power measurement may be determined by subtracting a reflected power value from an incident power value. In some examples, a table or function stored in the user equipment may indicate the correspondence between the power measurements and the absorbed power values.

An apparatus for wireless communications includes means for identifying, in a user equipment, one or more operating points based at least in part on stored calibration information that indicates a correspondence between signal power measurements and absorbed power values. The apparatus also includes means for selecting one of the one or more operating points for use with an operating mode of the user equipment. In some examples, the apparatus also includes means for selecting a radiated mode as the operating mode of the user equipment, and means for selecting one of the one or more operating points for use with the radiated mode. In some examples, the apparatus also includes means for configuring a switch in the user equipment to enable operation in the radiated mode. In some examples, the absorbed power value for each power measurement may be determined by subtracting a reflected power value from an incident power value. In some examples, a table or function stored in the user equipment may indicate the correspondence between the power measurements and the absorbed power values.

A computer program product includes a non-transitory computer-readable medium having code for causing at least one computer to identify, in a user equipment, one or more operating points based at least in part on stored calibration information that indicates a correspondence between signal power measurements and absorbed power values. The non-transitory computer-readable medium has code for causing the at least one computer to select one of the one or more operating points for use with an operating mode of the user equipment. In some examples, the non-transitory computer-readable medium may also have code for causing the at least one computer to select a radiated mode as the operating mode of the user equipment, and code for causing the at least one computer to select one of the one or more operating points for use with the radiated mode. In some examples, the non-transitory computer-readable medium may also have code for causing the at least one computer to configure a switch in the user equipment to enable operation in the radiated mode. In some examples, the absorbed power value for each power measurement may be determined by subtracting a reflected power value from an incident power value. In some examples, a table or function stored in the user equipment may indicate the correspondence between the power measurements and the absorbed power values.

An apparatus for wireless communications includes a calibration module configured to identify, in a user equipment, one or more operating points based at least in part on stored calibration information that indicates a correspondence between signal power measurements and absorbed power values. The apparatus also includes a selection module configured to select one of the one or more operating points for use with an operating mode of the user equipment. In some examples, the selection module may be further configured to select a radiated mode as the operating mode of the user equipment, and select one of the one or more operating points for use with the radiated mode. In some examples, the calibration module may be further configured to configure a switch in the user equipment to enable operation in the radiated mode. In some examples, the absorbed power value for each power measurement may be determined by subtracting a reflected power value from an incident power value. In some examples, a table or function stored in the user equipment may indicate the correspondence between the power measurements and the absorbed power values.

A system for calibrating a wireless communications device includes the wireless communication device coupled to a calibration equipment, the wireless communication device being configured to receive multiple signals from the calibration equipment, determine a power measurement for each of the signals, and receive, from the calibration equipment, absorbed power values corresponding to each of power measurements; and the calibration equipment configured to calibrate the wireless communications device using one or more of the absorbed power values and corresponding power measurements. In some examples, the calibration equipment may be further configured to determine the absorbed power value for each power measurement by subtracting a reflected power value from an incident power value. In some examples, the wireless communications device may be further configured to receive, from the calibration equipment, a table or function that indicates the correspondence between the absorbed power values and the power measurements. In some examples, the calibration equipment may be further configured to determine a mismatch loss between the wireless communication device and the calibration equipment, and calibrate the wireless communications device in accordance with the mismatch loss. In some examples, the calibration equipment may be further configured to determine a first SWR associated with the wireless communications device, determine a second SWR associated with the calibration equipment, combine the first and second SWR, and determine the mismatch loss based at least in part on the combined SWRs. In some examples, the wireless communications device may be further configured to determine an RSSI measurement as the power measurement for each of the signals. In some examples, the wireless communications device may be further configured to configure a switch in the wireless communications device to connect a test port of the wireless communication device with the calibration equipment.

A method for a wireless communications device includes providing a signal having an incident power to a receiver of the wireless communications device, measuring a reflected power of the signal from the receiver, determining an absorbed power of the signal at the receiver based on the incident power and the reflected power, and calibrating the wireless communications device based on the absorbed power. In some examples, the calibrating may include generating a calibration table associated with an RSSI value. In some examples, the method includes setting, based on the calibration table, an operating point of the wireless communications device when used in a radiated mode. In some examples, the determining the absorbed power may include subtracting the reflected power from the incident power. In some examples, the providing the signal may include coupling a calibration equipment with the receiver of the wireless communications device.

What is claimed is:

1. A method for operating a wireless communications device, comprising:
receiving a plurality of signals;
determining a power measurement for each of the plurality of signals;
receiving absorbed power values corresponding to each of the power measurements; and
calibrating the wireless communications device using one or more absorbed power values and the corresponding power measurements.

2. The method of claim 1, wherein the absorbed power values are determined by subtracting a reflected power value from an incident power value.

3. The method of claim 1, further comprising:
receiving a table or a function that indicates the correspondence between the absorbed power values and the power measurements.

4. The method of claim 1 wherein determining the power measurement for each of the plurality of signals includes determining a received strength indication (RSSI) measurement for each of the plurality of signals.

5. The method of claim 1, further comprising:
configuring a switch in the wireless communications device to connect a test port of the wireless communications device with a calibration equipment.

6. The method of claim 1 wherein the absorbed power values are determined based on a mismatch loss between the wireless communications device and a calibration equipment.

7. The method of claim 1 wherein the absorbed power values are determined based on a standing wave ratio (SWR) associated with the wireless communications device and the SWR associated with a calibration equipment.

8. The method of claim 1 wherein the plurality of signals and the absorbed power values are received from a calibration equipment.

9. An apparatus for operating a wireless communications device comprising:
means for receiving a plurality of signals;
means for determining a power measurement for each of the plurality of signals;
means for receiving absorbed power values corresponding to each of the power measurements; and
means for calibrating the wireless communications device using one or more of the absorbed power values and the corresponding power measurements.

10. The apparatus of claim 9, wherein the absorbed power values are determined by subtracting a reflected power value from an incident power value.

11. The apparatus of claim 9, further comprising:
means for receiving a table or a function that indicates the correspondence between the absorbed power values and the power measurements.

12. The apparatus of claim 9, wherein the means for determining the power measurement for each of the plurality of signals further comprises:
means for determining a received signal strength indication (RSSI) measurement for each of the plurality of signals.

13. The apparatus of claim 9, further comprising:
means for configuring a switch in the wireless communications device to connect a test port of the wireless communications device with a calibration equipment.

14. The apparatus of claim 9 wherein the absorbed power values are determined based on a mismatch loss between the wireless communications device and a calibration equipment.

15. The apparatus of claim 9 wherein the absorbed power values are determined based on a standing wave ratio (SWR) associated with the wireless communications device and the SWR associated with a calibration equipment.

16. The apparatus of claim 9 wherein the plurality of signals and the absorbed power values are received from a calibration equipment.

17. An apparatus for operating a wireless communications device comprising:
a processor communicatively coupled with a memory, wherein the memory stores computer program code that causes the processor to:
receive a plurality of signals;
determine a power measurement for each of the plurality of signals;
receive absorbed power values corresponding to each of the power measurements; and
calibrate the wireless communications device using one or more of the absorbed power values and the corresponding power measurements.

18. The apparatus of claim 17 wherein the absorbed power values are determined by subtracting a reflected power value from an incident power value.

19. The apparatus of claim 17 wherein the computer program code is further configured to cause the processor to receive a table or a function that indicates the correspondence between the absorbed power values and the power measurements.

20. The apparatus of claim 17, wherein the computer program code that causes the processor to determine power measurements for each of the plurality of signals is further configured to cause the processor to determine a received signal strength indication (RSSI) measurement for each of the plurality of signals.

21. The apparatus of claim 17, wherein the computer program code is further configured to cause the processor to select a calibration mode as a mode of operation for the wireless communications device.

22. The apparatus of claim 17 wherein the absorbed power values are determined based on a mismatch loss between the wireless communications device and a calibration equipment.

23. The apparatus of claim 17 wherein the absorbed power values are determined based on a standing wave ratio (SWR) associated with the wireless communications device and the SWR associated with a calibration equipment.

24. A computer program product, comprising:
a non-transitory computer-readable medium comprising:
code for causing at least one processor to receive a plurality of signals;
code for causing the at least one processor to determine a power measurement for each of the plurality of signals;
code for causing the at least one processor to receive absorbed power values corresponding to each of the power measurements; and
code for causing the at least one processor to calibrate a wireless communications device using one or more of the absorbed power values and the corresponding power measurements.

25. The computer program product of claim 24, wherein the absorbed power values are determined by subtracting a reflected power value from an incident power value.

26. The computer program product of claim 24, wherein the non-transitory computer-readable medium further comprises:
code for causing the at least one processor to receive a table or a function that indicates the correspondence between the absorbed power values and the power measurements.

27. The computer program product of claim 24, wherein the code for causing the at least one processor to determine the power measurement for each of the plurality of signals further comprises a code for causing the at least one processor to determine a received signal strength indication (RSSI) measurement for each of the plurality of signals.

28. The computer program product of claim 24, wherein the non-transitory computer-readable medium further comprises:
code for causing the at least one processor to configure a switch in the wireless communications device to connect a test port of the wireless communication device with a calibration equipment.

29. The computer program product of claim 24 wherein the absorbed power values are determined based on a mismatch loss between the wireless communications device and a calibration equipment.

30. The computer program product of claim 24 wherein the absorbed power values are determined based on a standing wave ratio (SWR) associated with the wireless communications device and the SWR associated with a calibration equipment.
